(19) United States
(12) Patent Application Publication
(10) Pub. No.: US 2007/0019931 A1
(43) Pub. Date: Jan. 25, 2007

(54) Systems and methods for re-synchronizing video and audio data

(75) Inventor: Mihai G. Sirbu, Germantown, MD (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/184,371

(22) Filed: Jul. 19, 2005

(51) Int. Cl. H04N 7/00

(52) U.S. Cl. 386/96

(57) ABSTRACT

Systems and methods are provided for re-synchronizing video and audio data. The systems and methods compare a video count associated with a video jitter buffer with a predefined video count. A given audio silence period in audio data associated with an audio jitter buffer is adjusted in response to the video count of the video jitter buffer being outside a predetermined amount of the predefined video count, until the video count is within the predetermined amount of the predefined video count.

### TECHNICAL FIELD

The present invention relates generally to data processing, and more particularly to systems and methods for re-synchronizing video and audio data.

### BACKGROUND

Computer systems and more generally data processing systems that utilize time dependent data, such as audio data or video data, to produce a time dependent presentation require a synchronization mechanism to synchronize the processing and display of time dependent data. Without synchronization, time dependent data cannot be retrieved, processed, and used at the appropriate time. As a result, the time dependent presentation would have a discontinuity due to the unavailability of the data. In the case of video data, there is typically a sequence of images (“frames”) which, when the images are displayed in rapid sequence (e.g., each frame being displayed for 1/30th of a second immediately after displaying a prior frame), creates the impression of a motion picture. With the video images, the discontinuity would manifest itself as a stutter in the video image or a freeze-up (e.g., a single frame being displayed considerably longer than 1/30th of a second) in the video image. With audio presentations, this discontinuity would manifest itself as a period of silence, a pause, clicks, or stuttering.

In real-time video teleconferencing, digital streams of audio and video data are transmitted between two users over different channels. The audio and video data is time stamped at the transmitter, and transmitted over a network to a receiver. The receiver separates the audio and video data, and stores the audio and video data into storage buffers. The receiver synchronizes the audio and video data for playback at the receiver. The storage buffers retain a predefined amount of video and audio data to mitigate playback delay. However, the latency associated with the video data is typically greater than the latency associated with the audio data due to the size of the video data, and the amount of time to encode and decode the video data with respect to the audio data. Therefore, the video stream is often out of synchronization with the audio stream causing degradation of audio quality.

### SUMMARY

In one aspect of the present invention, a system is provided for re-synchronizing real-time video data and audio data for playback. The system comprises an audio jitter buffer operative to receive audio data and a video jitter buffer operative to receive video data. The system further comprises a re-synchronization control that adjusts a given audio silence period in the received audio data in response to a video count of the video jitter buffer being outside a predetermined amount of a predefined video count.

In another aspect of the present invention, a video/audio communication unit is provided. The video/audio communication unit comprises means for buffering audio data associated with a real-time audio stream, means for buffering video data associated with a real-time video stream and means for synchronizing the playback of the audio data with the video data. The video/audio communication unit further comprises means for re-synchronizing the means for buffering audio data with the means for buffering video data in response to the means for buffering video data having a video count that is outside a predetermined amount of a predefined video count.

In yet another aspect of the present invention, a method is provided for re-synchronizing real-time video data and audio data for playback. The method comprises determining silence periods within audio data associated with an audio jitter buffer, comparing a video count associated with a video jitter buffer with a predefined video count, and adjusting a given audio silence period in the audio data in response to a video count of the video jitter buffer being outside a predetermined amount of the predefined video count.

### BRIEF DESCRIPTION OF THE DRAWINGS

FIG. 1 illustrates a block diagram of a real-time video teleconferencing system in accordance with an aspect of the present invention.

FIG. 2 illustrates a block diagram of a portion of a receiver of a video/audio communication unit in accordance with an aspect of the present invention.

FIG. 3 illustrates a block diagram of a re-synchronization control in accordance with an aspect of the present invention.

FIG. 4 illustrates a flow diagram of a methodology for re-synchronizing real-time audio and video data for playback in accordance with an aspect of the present invention.

### DETAILED DESCRIPTION

Systems and methods are provided for re-synchronizing video and audio data. The systems and methods compare a video count associated with a video jitter buffer with a predefined video count. A given audio silence period in audio data associated with an audio jitter buffer is adjusted in response to the video count of the video jitter buffer being outside a predetermined amount of the predefined video count. For example, playback of audio data can be delayed in response to the video count being below the predefined video count by the predetermined amount, until the video count falls within the predetermined amount of the predefined video count. Additionally, data in the given audio silence period can be removed in response to the video count being above the predefined video count by the predetermined amount, until the video count falls within the predetermined amount of the predefined video count.

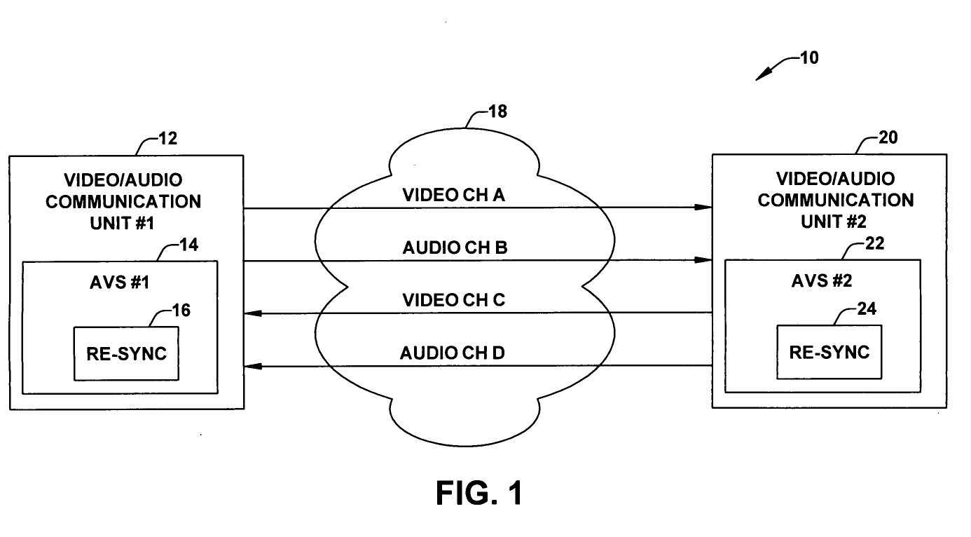

FIG. 1 illustrates a real-time video teleconferencing system 10 in accordance with an aspect of the present invention. The real-time video teleconferencing system 10 includes a first video/audio communication unit 12 coupled to a second video/audio communication unit 20 via a network 18. The first and second video/audio communication units 12 and 20 can be, for example, video phones, computer systems, teleconference devices or other video/audio communication systems. The network 18 can be, for example, a telephone network, a computer network, a cellular network or other network types. The first video/audio communication unit 12 transmits video data over a channel A and associated audio data over a channel B to the second video/audio communication unit 20. The second video/audio communication unit 20 transmits video data over a channel C and associated audio data over a channel D to the first video/audio communication unit 12. The audio and video data is streamed between the first video/audio communication unit 12 and the second video/audio communication unit 20 in real-time.

The first video/audio communication unit 12 includes an audio video synchronizer (AVS) 14 that synchronizes the audio and video data received from the second video/audio communication unit 20 based on time stamp information in the audio and video data inserted at the second video/audio communication unit 20. Additionally, the second video/audio communication unit 20 an AVS 22 that synchronizes the audio and video data received from the first video/audio communication unit 12 based on time stamp information in the audio and video data inserted at the first video/audio communication unit 12. The AVS 14 and the AVS 22 can include both hardware and software to facilitate synchronizing playback of the respective audio and video data at the respective video/audio communication unit. The audio data can be digitized and transmitted over the network as packets (e.g., voice over internet protocol (VOIP)). The video data can be digitized, and encoded such as in a Moving Picture Experts Group (MPEG) format and transmitted over the network as packets.

The AVS 14 includes a re-synchronization control 16 and the AVS 22 includes a re-synchronization control 24. Both the re-synchronization control 14 and 24 compensate for jitter delay associated with the audio and video streams being received by the respective video/audio communication unit. The jitter delay is defined as the difference between an actual amount of transmission delay time with respect to an expected amount of transmission delay time. Jitter delay is due to varying transmission loads, congestions associated with the network and other factors associated with the transmission of the video and audio data, such that the transmission delay associated with the video and/or audio stream can vary from the expected amount. Each AVS has an associated audio jitter buffer and video jitter buffer, which stores a predefined amount of audio and video data, respectively, for playback.

For example, the audio jitter buffer and the video jitter buffer can retain about 2-7 audio and video samples or packets. The video jitter buffer may receive new samples or packets every 33 ms, while the audio jitter buffer may receive new samples or packets every 10 ms. Additionally, there is typically more latency associated with the video stream than the audio stream due to the size of the video samples or packets versus the size of the audio samples and packets in addition to the longer processing time associated with encoding and decoding video data versus audio data. Therefore, it is important to retain enough video data in the video jitter buffer to facility playback quality of service (QOS).

In accordance with an aspect of the present invention, the re-synchronization controls 16 and 24 monitor the video count in the video jitter buffer by comparing the video count with a predefined video count. If the video count is less than a predetermined amount below the predefined count, the re-synchronization control delays audio playback during a detected silence period to extend the playback of the silence period or to inject additional silence into the playback, until the video jitter buffer reaches a predetermined amount within a desired predefined video count. The predetermined amount can be one or more samples or packets of data in the jitter buffer. If the video count is greater than the predefined count by a predetermined amount, the re-synchronization control decreases the amount of silence in a detected silence period by, for example, dropping silence data or packets from the audio jitter buffer. The predefined video count can be an integer, fraction or a count range.

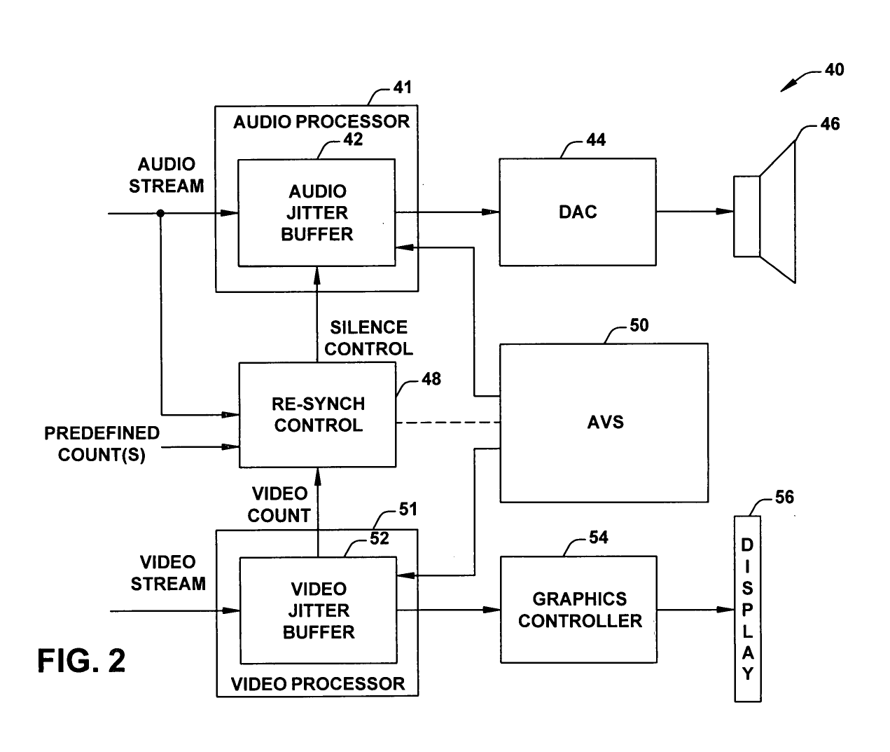

FIG. 2 illustrates a portion of a receiver 40 of a video/audio communication unit in accordance with an aspect of the present invention. The receiver 40 includes an audio jitter buffer 42 operative for receiving an audio stream and a video jitter buffer 52 operative for receiving a video stream. The audio jitter buffer 42 is part of an audio processor 41, and the video jitter buffer 52 is part of a video processor 51. The audio stream is received by the audio processor 41 and the video stream is received by the video processor 51. The receiver 40, the audio processor 41 and the video processor 51 cooperate to route, decode and/or demodulate the received audio and video data, remove header and trailer information and provide the post processed raw audio and video data to the audio jitter buffer 42 and the video jitter buffer 52 in playback form. Alternatively, the audio and video stream can be in the form of preprocessed data for storing in the audio jitter buffer 42 and the video jitter buffer 52. The audio and video stream data would then have to be processed into playback form prior to playback by the video/audio communication unit.

An AVS unit 50 controls the synchronization of the video data and audio data to provide concurrent playback. The AVS unit 50 outputs audio data from the audio jitter buffer 42 concurrently with video data from the video jitter buffer 52 that have a same time stamp to synchronize the appropriate audio data with the appropriate video data. The audio data is provided from the audio jitter buffer 42 to a digital-to-analog converter (DAC) 44, which converts the audio data into analog voice signals for playback via a speaker 46. The video data is provided from the video jitter buffer 52 to a graphics controller 54 that converts the video data into a displayable format for displaying at a display 56.

The receiver 40 also includes a re-synchronization control 48. The re-synchronization control 48 can be part of the AVS 50, such that the re-synchronization control 48 is a unit of hardware and/or a software algorithm that executes within the AVS 50. The re-synchronization control 48 receives the audio stream and determines periods of silence that resides in the audio stream. Alternatively, the re-synchronization control 48 can monitor the audio jitter buffer 42 to determine periods of silence within the stored audio data. If the audio stream includes silence insertion descriptor (SID) packets, the re-synchronization control 48 can employ the SID packets to determine periods of silence in the audio stream or audio jitter buffer 42. If the audio stream does not include SID packets, the re-synchronization control 48 can measure silence employing techniques such as determining the average power or average volume of the audio stream, or other a variety of other techniques for detecting silence in an audio stream. A separate silence detection component can be employed outside of the re-synchronization control, 48 and the silence information placed in the stream or another location accessible to the re-synchronization control 48.

The re-synchronization control 48 monitors the video count in the video jitter buffer 52 by comparing the video count with a predefined video count. If the video count is less than a predetermined amount below the predefined count, the re-synchronization control 48 delays audio playback via a silence control signal to the audio jitter buffer 42. The silence control signal can alternatively be provided to the AVS 50 for controlling the amount of silence playback of the audio jitter buffer 52. If the video count is greater than a predetermined amount above the predefined count, the re-synchronization control 48 decreases the amount of silence in a detected silence period by, for example, dropping silence data or packets from the audio jitter buffer 48 via the silence control signal.

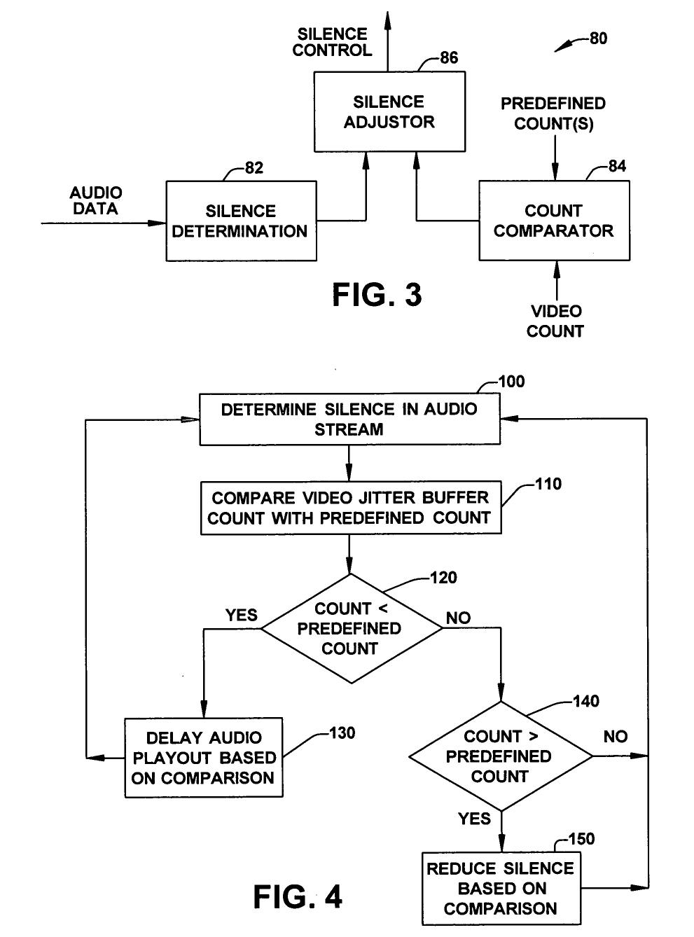

FIG. 3 illustrates a re-synchronization control 80 in accordance with an aspect of the present invention. The re-synchronization control 80 includes a silence determination component 82 that receives audio data that corresponds to an incoming audio stream or audio data residing in an audio jitter buffer. The silence determination component 82 determines locations within the audio data that contain periods of silence. The periods of silence can be determined by measuring average power or average volume of the audio data or determining if SID packets reside within the audio data. The silence determination component 82 provides the detected silence information to a silence adjustor 86. The re-synchronization control 80 also includes a count comparator 84. The count comparator 84 compares a video count in a video jitter buffer with a predefined count, and provides a difference value to the silence adjustor 86. The silence adjustor 86 employs the difference value and the period of silence information to dynamically determine if an adjustment to a silence period should be invoked.

For example, if the video count is below the predefined count by a predetermined amount, the silence adjustor 86 provides a silence control signal that indicates that a given period of silence should be increased by delaying the playback of audio data for a given time period, until the video count falls within a predetermined amount of the predefined count. If the video count is above the predefined count by a predetermined amount, the silence adjustor 86 provides a silence control signal that indicates that a given period of silence should be decreased by dropping a given amount of silence audio data, until the video count falls within a predetermined amount of the predefined count.

In view of the foregoing structural and functional features described above, a methodology in accordance with various aspects of the present invention will be better appreciated with reference to FIG. 4. While, for purposes of simplicity of explanation, the methodology of FIG. 4 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 4 illustrates a methodology for re-synchronizing real-time audio and video data for playback in accordance with an aspect of the present invention. The methodology begins at 100 where silence is determined in an audio stream. The silence can be determined by evaluating the average power or average volume of the audio stream, or by determining if the audio stream includes SID packets. At 110, a video count associated with a video jitter buffer is compared with a predefined count. The methodology then proceeds to 120. At 120, the methodology determines if the video count is below the predefined count by a predetermined amount. If the video count is below the predefined count by a predetermined amount (YES), the methodology proceeds to 130. At 130, the audio playback is delayed based on the comparison, until the video jitter buffer contains a video count within the predetermined amount of the predefined count. The methodology then returns to 100 to process the next audio stream.

If the video count is not below the predefined count by a predetermined amount (NO), the methodology proceeds to 140. At 140, the methodology determines if the video count is above the predefined count by a predetermined amount. If the video count is not above the predefined count by a predetermined amount (NO), the methodology returns to 100 to process the next audio stream. If the video count is above the predefined count by a predetermined amount (YES), the methodology proceeds to 150. At 150, the silence of a given silence period is reduced based on the comparison, until the video jitter buffer contains a video count within a predetermined amount of the predefined count. The methodology then returns to 100 to process the next audio stream.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A system for re-synchronizing real-time video data and audio data for playback, the system comprising:
an audio jitter buffer operative to receive audio data;
a video jitter buffer operative to receive video data; and
a re-synchronization control that adjusts a given audio silence period in the received audio data in response to a video count of the video jitter buffer being outside a predetermined amount of a predefined video count.

2. The system of claim 1, wherein the re-synchronization control delays playback of audio data during the given audio silence period in response to the video count being below the predefined video count by the predetermined amount, until the video count falls within the predetermined amount of the predefined video count.

3. The system of claim 1, wherein the re-synchronization control removes data in the given audio silence period in response to the video count being above the predefined video count by the predetermined amount, until the video count falls within the predetermined amount of the predefined video count.

4. The system of claim 1, wherein the re-synchronization control determines locations of silence periods within the audio data by locating silence insertion descriptor (SID) packets within the audio data.

5. The system of claim 1, wherein the re-synchronization control determines locations of silence periods within the audio data by measuring one of average power and average volume of the audio data.

6. The system of claim 1, further comprising a silence detection component separate from the re-synchronization control, the silence detection component determines locations of silence periods within the audio data by locating silence insertion descriptor (SID) packets within the audio data.

7. The system of claim 1, further comprising a silence detection component separate from the re-synchronization control, the silence detection component determines locations of silence periods within the audio data by measuring one of average power and average volume of the audio data.

8. The system of claim 1, wherein the audio data and the video data are stored in the audio jitter buffer and video jitter buffer, respectively, in one of post processed and pre-processed form.

9. The system of claim 1, further comprising:
an audio video synchronization unit that synchronizes the playback of the audio data from the audio jitter buffer and the video data from the video jitter buffer based on time stamps associated with the audio and video data;
a digital-to-analog converter that converts the audio data into an analog audio signal;
a speaker that converts the analog audio signal into a speech pattern;
a graphics controller that converts the video data into a displayable format; and
a display for displaying the displayable format video data.

10. A video/audio communication unit comprising the system of claim 1.

11. A video/audio communication unit comprising:
means for buffering audio data associated with a real-time audio stream;
means for buffering video data associated with a real-time video stream;
means for synchronizing the playback of the audio data with the video data; and
means for re-synchronizing the means for buffering audio data with the means for buffering video data in response to the means for buffering video data having a video count that is outside a predetermined amount of a predefined video count.

12. The communication unit of claim 11, wherein the means for re-synchronizing adjusts a given silence period within the audio data in response to the means for buffering video data having a video count that is outside a predetermined amount of a predefined video count.

13. The communication unit of claim 12, further comprising means for determining silence within the audio data, the means for re-synchronizing employing the determined silence for adjusting the given silence period.

14. The communication unit of claim 11, wherein the means for re-synchronizing comprises means for comparing the video count with the predefined video count and means generating a silence control signal based on a comparison by the means for comparing, the silence control signal adjusting a given silence period within the audio data if the video count is outside a predetermined amount of a predefined video count.

15. The communication unit of claim 11, wherein the means for re-synchronizing delays playback of audio data in response to the video count being below the predefined video count by the predetermined amount and removes data in the given audio silence period in response to the video count being above the predefined video count by the predetermined amount.

16. A method for re-synchronizing real-time video data and audio data for playback, the method comprising:
determining silence periods within audio data associated with an audio jitter buffer;
comparing a video count associated with a video jitter buffer with a predefined video count; and
adjusting a given audio silence period in the audio data in response to a video count of the video jitter buffer being outside a predetermined amount of the predefined video count.

17. The method of claim 16, wherein the given audio silence period is extended in response to the video count being below the predefined video count by the predetermined amount.

18. The method of claim 16, wherein the given audio silence period is decreased in response to the video count being above the predefined video count by the predetermined amount.

19. The method of claim 16, wherein determining silence periods within audio data comprises locating silence insertion descriptor (SID) packets within the audio data.

20. The method of claim 16, wherein determining silence periods within audio data comprises measuring one of average power and average volume of the audio data to locate silence periods within the audio data.
